(19) United States
(12) Patent Application Publication
(10) Pub. No.: US 2025/0379213 A1
(43) Pub. Date: Dec. 11, 2025

(54) POSITIVE ELECTRODE FOR NONAQUEOUS ELECTROLYTE SECONDARY BATTERIES AND NONAQUEOUS ELECTROLYTE SECONDARY BATTERY, BATTERY MODULE, AND BATTERY SYSTEM USING SAME, AND METHOD FOR PRODUCING POSITIVE ELECTRODE FOR NONAQUEOUS ELECTROLYTE SECONDARY BATTERIES

(71) Applicant: SEKISUI CHEMICAL CO., LTD., Osaka (JP)

(72) Inventors: Hikaru YOSHIKAWA, Tsukuba-shi (JP); Yuichi SABI, Tsukuba-shi (JP)

(73) Assignee: SEKISUI CHEMICAL CO., LTD., Osaka (JP)

(21) Appl. No.: 18/878,740

(22) PCT Filed: Jul. 4, 2023
(86) PCT No.: PCT/JP2023/024727

§ 371 Date: Dec. 24, 2024

(30) Foreign Application Priority Data
Jul. 4, 2022 (JP) 2022-107768

(51) Int. Cl. H01M 4/136; H01M 4/02; H01M 4/04; H01M 4/1397; H01M 4/58; H01M 4/66

(52) U.S. Cl. CPC H01M 4/136; H01M 4/0404; H01M 4/043; H01M 4/1397; H01M 4/5825; H01M 4/661; H01M 2004/021; H01M 2004/028

(57) ABSTRACT

A positive electrode for a non-aqueous electrolyte secondary battery, including: a positive electrode current collector including a positive electrode current collector main body formed of a metal material; and a positive electrode active material layer provided on the positive electrode current collector, wherein: the positive electrode active material layer includes a positive electrode active material; the positive electrode active material has, on at least a part of its surface, an active material coating section including a conductive material; the positive electrode current collector main body has, on at least a part of its surface on a side of the positive electrode active material layer, a current collector coating layer including a conductive material; and a ratio of thickness of the current collector coating layer to thickness of the positive electrode active material layer is more than 0.000 and less than 0.020.

### TECHNICAL FIELD

The present invention relates to a positive electrode for a non-aqueous electrolyte secondary battery, as well as a non-aqueous electrolyte secondary battery, a battery module, and a battery system, each using the positive electrode, and also relates to a method for producing a positive electrode for a non-aqueous electrolyte secondary battery.

Priority is claimed on Japanese Patent Application No. 2022-107768, filed Jul. 4, 2022, the contents of which are incorporated herein by reference.

### BACKGROUND ART

A non-aqueous electrolyte secondary battery is generally composed of a positive electrode, a non-aqueous electrolyte, a negative electrode, and a separation membrane (hereinafter, also referred to as “separator”) installed between the positive electrode and the negative electrode.

A conventionally known positive electrode for a non-aqueous electrolyte secondary battery is formed by fixing a composition composed of a positive electrode active material containing lithium ions, a conducting agent, and a binder to the surface of a metal foil as a current collector.

Examples of the practically used positive electrode active material containing lithium ions include lithium transition metal composite oxides such as lithium cobalt oxide, lithium nickel oxide, and lithium manganese oxide, and lithium phosphate compounds such as lithium iron phosphate.

Patent Document 1 relates to a non-aqueous electrolyte secondary having a positive electrode provided with a conductive coating layer using carbon as a conducting agent between an aluminum foil current collector and a positive electrode active material layer containing a lithium transition metal composite oxide. The Examples thereof show that, when the positive electrode active material layer thickness b is constant, the cycle life performance improves and the initial capacity decreases as the conductive coating layer thickness a increases, and it is described that, when the value of a/b is 0.02 to 0.1, the capacity can be retained and good cycle life performance is shown.

### PRIOR ART DOCUMENT

### Patent Document

Patent Document 1: Japanese Unexamined Patent Application Publication No. 2001-351612

### SUMMARY OF THE INVENTION

### Problems to be Solved by the Invention

The method described in Patent Document 1 is not necessarily satisfactory, and further improvement of battery performance is required.

The present invention provides a positive electrode for a non-aqueous electrolyte secondary battery, which is capable of reducing the impedance of the non-aqueous electrolyte secondary battery.

### Means for Solving the Problems

The embodiments of the present invention are as follows.

[1]A positive electrode for a non-aqueous electrolyte secondary battery, comprising: a positive electrode current collector comprising a positive electrode current collector main body formed of a metal material; and a positive electrode active material layer provided on the positive electrode current collector, wherein: the positive electrode active material layer comprises a positive electrode active material; the positive electrode active material has, on at least a part of its surface, an active material coating section comprising a conductive material; the positive electrode current collector main body has, on at least a part of its surface on a side of the positive electrode active material layer, a current collector coating layer comprising a conductive material; the positive electrode active material layer has a thickness of 1 to 100 nm; and a ratio of thickness of the current collector coating layer to thickness of the positive electrode active material layer is more than 0.000 and less than 0.020.

[2] The positive electrode for a non-aqueous electrolyte secondary battery according to [1], wherein the positive electrode active material layer is present on both surfaces of the positive electrode current collector, and a total mass per unit area of the positive electrode active material layer on the both surfaces is 30 to 150 mg/cm².

[3] The positive electrode according to [1] or [2], wherein the positive electrode active material layer has a peel strength of 7 to 1,000 mN/cm.

[4] The positive electrode according to any one of [1] to [3], wherein the positive electrode active material layer is present on both surfaces of the positive electrode current collector, and a thickness of the positive electrode excluding the positive electrode current collector main body is 50 to 500 km.

[5] The positive electrode active material according to any one of [1] to [4], wherein the positive electrode active material includes a compound represented by a formula LiFeₓM₍₁₋ₓ₎PO₄, wherein 0≤x≤1, M is Co, Ni, Mn, Al, Ti or Zr.

[6] The positive electrode according to [5], wherein the positive electrode active material is lithium iron phosphate represented by LiFePO₄.

[7] The positive electrode according to any one of [1] to [6], wherein the positive electrode active material layer further includes a conducting agent.

[8] The positive electrode according to any one of [1] to [6], wherein the positive electrode active material layer does not contain a conducting agent.

[8-1] The positive electrode according to any one of [1] to [8], wherein the active material coating section has a thickness of 5 to 100 nm or 3 to 100 nm.

[8-2] The positive electrode according to any one of [1] to [8], wherein the active material coating section has a thickness of 3 to 52 nm, 5 to 52 nm, or 5 to 45 nm.

[8-3] The positive electrode according to any one of [1] to [8-2], wherein a ratio of thickness of the current collector coating layer to thickness of the positive electrode active material layer is 0.005 to 0.015.

[8-4] The positive electrode according to any one of [1] to [8-2], wherein the thickness of the positive electrode active material layer is 130 to 145 μm, and a ratio of thickness of the current collector coating layer to thickness of the positive electrode active material layer is more than 0.0013 to 0.015.

[9]A non-aqueous electrolyte secondary battery, comprising the positive electrode of any one of [1] to [8], a negative electrode, and a non-aqueous electrolyte disposed between the positive electrode and the negative electrode.

[10]A battery module or battery system comprising a plurality of the non-aqueous electrolyte secondary batteries of [9].

[11]A method for producing a positive electrode for a non-aqueous electrolyte secondary battery, comprising: an active material layer-forming step of applying a positive electrode composition containing a positive electrode active material, a binder and a solvent onto a positive electrode current collector, followed by drying the positive electrode composition to form a positive electrode active material layer on the positive electrode current collector, wherein: the positive electrode current collector has a positive electrode current collector main body formed of a metal material, and a current collector coating layer covering at least a part of surface of the positive electrode current collector main body, the positive electrode active material has, on at least a part of its surface, an active material coating section comprising a conductive material, and the active material layer-forming step is performed to press a laminate in which the positive electrode active material layer is formed on the positive electrode collector in a thickness direction against a surface of the positive electrode collector having the current collector coating layer, so that a ratio of thickness of the current collector coating layer to thickness of the positive electrode active material layer is adjusted to more than 0.000 and less than 0.020.

[12]A method for producing a non-aqueous electrolyte secondary battery, comprising:
a step of producing a positive electrode for a non-aqueous electrolyte secondary battery by the method of [11]; and
a non-aqueous electrolyte-forming step of disposing a non-aqueous electrolyte between the positive electrode for a non-aqueous electrolyte secondary battery and a negative electrode.

### Effect of the Invention

The present invention can provide a positive electrode for a non-aqueous electrolyte secondary battery, which is capable of reducing the impedance of the non-aqueous electrolyte secondary battery.

### BRIEF DESCRIPTION OF THE DRAWINGS

FIG. 1 is a cross-sectional view schematically showing an example of a positive electrode for a non-aqueous electrolyte secondary battery according to the present invention.

FIG. 2 is a cross-sectional view schematically showing an example of a non-aqueous electrolyte secondary battery according to the present invention.

FIG. 3 is a process diagram for explaining a method for measuring the peel strength of a positive electrode active material layer.

### DESCRIPTION OF EMBODIMENTS

In the present specification and claims, “to” indicating a numerical range means that the numerical values described before and after “to” are included as the lower limit and the upper limit of the range.

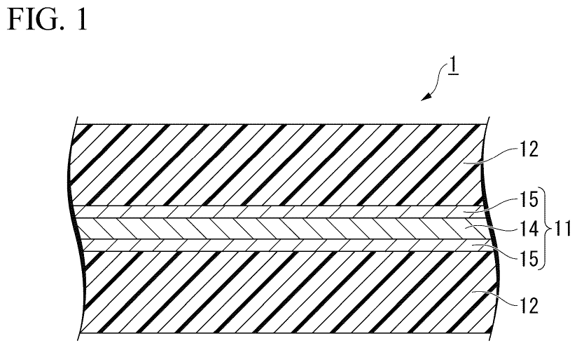

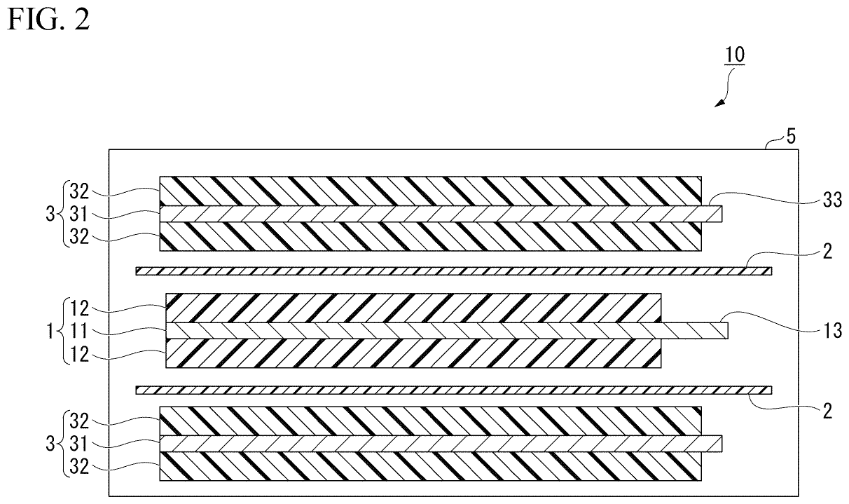

FIG. 1 is a schematic cross-sectional view showing one embodiment of the positive electrode of the present invention for a non-aqueous electrolyte secondary battery, and FIG. 2 is a schematic cross-sectional view showing one embodiment of the non-aqueous electrolyte secondary battery of the present invention.

FIG. 1 and FIG. 2 are schematic diagrams for facilitating the understanding of the configurations, and the dimensional ratios and the like of each component do not necessarily represent the actual ones.

### <Positive Electrode for Non-Aqueous Electrolyte Secondary Battery>

In the present embodiment, the positive electrode for a non-aqueous electrolyte secondary battery (also simply referred to as “positive electrode”) 1 has a positive electrode current collector 11 and a positive electrode active material layer 12.

The positive electrode active material layer 12 is present on at least one surface of the positive electrode current collector 11. The positive electrode active material layers 12 may be present on both sides of the positive electrode current collector 11.

In the example shown in FIG. 1, the positive electrode current collector 11 has a positive electrode current collector main body 14 and current collector coating layers 15 that cover the positive electrode current collector main body 14 on its surfaces facing the positive electrode active material layers 12.

### [Positive Electrode Active Material Layer]

The positive electrode active material layer 12 includes a positive electrode active material. The positive electrode active material layer 12 preferably further includes a binder. The positive electrode active material layer 12 may further include a conducting agent.

The shape of the positive electrode active material is preferably particulate.

The amount of the positive electrode active material is preferably 80.0 to 99.9% by mass, and more preferably 90 to 99.5% by mass, based on the total mass of the positive electrode active material layer 12.

The positive electrode active material has, on at least a part of its surface, a coated section including a conductive material.

The conductive material of the coated section of the active material preferably contains carbon. The conductive material may be composed only of carbon, or may be a conductive organic compound containing carbon and elements other than carbon. Examples of the other elements include nitrogen, hydrogen, oxygen and the like. In the conductive organic compound, the amount of the other elements is preferably 10 atomic % or less, and more preferably 5 atomic % or less.

It is more preferable that the conductive material in the active material coating section is composed only of carbon.

The amount of the conductive material is 0.1 to 3.0% by mass, more preferably 0.5 to 1.5% by mass, even more preferably 0.7 to 1.3% by mass, based on the total mass of the positive electrode active material including the coated section.

The positive electrode active material preferably contains a compound having an olivine crystal structure.

The compound having an olivine crystal structure is preferably a compound represented by the following formula: LiFeₓM₍₁₋ₓ₎PO₄ (hereinafter, also referred to as “formula (I)”). In the formula (I), 0≤x≤1. M is Co, Ni, Mn, Al, Ti or Zr. A minute amount of Fe and M (Co, Ni, Mn, Al, Ti or Zr) may be replaced with another element so long as the replacement does not affect the physical properties of the compound. The presence of a trace amount of metal impurities in the compound represented by the formula (I) does not impair the effect of the present invention.

The compound represented by the formula (T) is preferably lithium iron phosphate represented by LiFePO₄ (hereinafter, also referred to as “lithium iron phosphate”). The compound is more preferably lithium iron phosphate particles each having, on at least a part of its surface, a coated section including a conductive material (hereinafter, also referred to as “coated lithium iron phosphate particles”). It is more preferable that the entire surface of lithium iron phosphate particles is coated with a conductive material for achieving more excellent battery capacity and cycling performance.

The coated lithium iron phosphate particles can be produced by a known method.

For example, the coated lithium iron phosphate particles can be obtained by a method in which a lithium iron phosphate powder is prepared by following the procedure described in Japanese Patent No. 5098146, and at least a part of the surface of lithium iron phosphate particles in the powder is coated with carbon by following the procedure described in GS Yuasa Technical Report, June 2008, Vol. 5, No. 1, pp. 27-31 and the like.

Specifically, first, iron oxalate dihydrate, ammonium dihydrogen phosphate, and lithium carbonate are weighed to give a specific molar ratio, and these are pulverized and mixed in an inert atmosphere. Next, the obtained mixture is heat-treated in a nitrogen atmosphere to prepare a lithium iron phosphate powder. Then, the lithium iron phosphate powder is placed in a rotary kiln and heat-treated while supplying methanol vapor with nitrogen as a carrier gas to obtain a powder of lithium iron phosphate particles having at least a part of their surfaces coated with carbon.

For example, the particle size of the lithium iron phosphate powder can be adjusted by optimizing the pulverization time in the pulverization process. The amount of carbon coating the particles of the lithium iron phosphate powder can be adjusted by optimizing the heating time and temperature in the step of implementing heat treatment while supplying methanol vapor. It is desirable to remove the carbon particles not consumed for coating by subsequent steps such as classification and washing.

The positive electrode active material may contain other positive electrode active materials than the compound having an olivine type crystal structure.

Preferable examples of the other positive electrode active materials include a lithium transition metal composite oxide. Specific examples thereof include lithium cobalt oxide, lithium nickel oxide, lithium nickel cobalt aluminum oxide (LiNiₓCo_{y}Al_{z}O₂ with the proviso that x+y+z=1), lithium nickel cobalt manganese oxide (LiNiₓCo_{y}Mn_{z}O₂ with the proviso that x+y+z=1), lithium manganese oxide, lithium manganese cobalt oxide, lithium manganese chromium oxide, lithium vanadium nickel oxide, nickel-substituted lithium manganese oxide (e.g., LiMn_{1.5}Ni_{0.5}O₄), and lithium vanadium cobalt oxide (LiCoVO₄), as well as nonstoichiometric compounds formed by partially substituting the compounds listed above with metal elements. Examples of the metal element include one or more selected from the group consisting of Mn, Mg, Ni, Co, Cu, Zn and Ge.

With respect to the other positive electrode active materials, a single type thereof may be used individually or two or more types thereof may be used in combination.

The other positive electrode active material may have, on at least a part of its surface, the coated section described above.

The amount of the compound having an olivine type crystal structure is preferably 50% by mass or more, preferably 80% by mass or more, and even more preferably 90% by mass or more, based on the total mass of the positive electrode active material. The amount of the compound having an olivine type crystal structure may be 100% by mass, based on the total mass of the positive electrode active material particles.

When the coated lithium iron phosphate particles are used, the amount of the coated lithium iron phosphate particles is preferably 50% by mass or more, more preferably 80% by mass or more, and even more preferably 90% by mass or more, based on the total mass of the positive electrode active material. This amount may be 100% by mass.

The thickness of the active material coating section of the positive electrode active material is 1 to 100 nm, preferably 3 to 100 nm or 5 to 100 nm, more preferably 3 to 52 nm or 5 to 52 nm, further preferably 5 to 45 nm.

The thickness of the coated section of the positive electrode active material can be measured by a method of measuring the thickness of the coated section in a transmission electron microscope (TEM) image of the positive electrode active material. The thickness of the coated section on the surface of the positive electrode active material need not be uniform. It is preferable that the positive electrode active material has, on at least a part of its surface, the coated section having a thickness of 1 nm or more, and the maximum thickness of the coated section is 100 nm or less.

The average particle size of the positive electrode active material particles (that is, positive electrode active material powder) is, for example, preferably 0.1 to 20.0 μm, more preferably 0.2 to 10.0 μm. When two or more types of positive electrode active materials are used, the average particle size of each of such positive electrode active materials may be within the above range.

The average particle size of the positive electrode active material in the present specification is a volume-based median particle size measured using a laser diffraction/scattering particle size distribution analyzer.

The binder that can be contained in the positive electrode active material layer 12 is an organic substance, and examples thereof include polyacrylic acid, lithium polyacrylate, polyvinylidene fluoride, polyvinylidene fluoride-hexafluoropropylene copolymers, styrene butadiene rubbers, polyvinyl alcohol, polyvinyl acetal, polyethylene oxide, polyethylene glycol, carboxymethyl cellulose, polyacrylic nitrile, and polyimide. With respect to the binder, a single type thereof may be used alone or two or more types thereof may be used in combination.

The amount of the binder in the positive electrode active material layer 12 is, for example, preferably 4.0% by mass or less, more preferably 2.0% by mass or less, based on the total mass of the positive electrode active material layer 12. When the amount of the binder is not more than the above upper limit value, the proportion of the substance that does not contribute to the conduction of lithium ions in the positive electrode active material layer 12 is reduced, and the battery performance can be further improved.

When the positive electrode active material layer 12 contains a binder, the lower limit of the amount of the binder is preferably 0.1% by mass or more, more preferably 0.5% by mass or more, based on the total mass of the positive electrode active material layer 12.

Examples of the conducting agent contained in the positive electrode active material layer 12 include carbon materials such as graphite, graphene, hard carbon, Ketjen black, acetylene black, and carbon nanotube. With respect to the conducting agent, a single type thereof may be used alone or two or more types thereof may be used in combination.

The amount of the conducting agent in the positive electrode active material layer 12 is, for example, preferably 4 parts by mass or less, more preferably 3 parts by mass or less, and even more preferably 1 part by mass or less, relative to 100 parts by mass of the positive electrode active material.

When the conducting agent is incorporated into the positive electrode active material layer 12, the lower limit value of the amount of the conducting agent is appropriately determined according to the type of the conducting agent, and is, for example, more than 0.1% by mass, based on the total mass of the positive electrode active material layer 12.

In the context of the present specification, the expression “the positive electrode active material layer 12 does not contain a conducting agent” or similar expression means that the positive electrode active material layer 12 does not substantially contain a conducting agent, and should not be construed as excluding a case where a conducting agent is contained in such an amount that the effects of the present invention are not affected. For example, if the amount of the conducting agent is 0.1% by mass or less, based on the total mass of the positive electrode active material layer 12, then, it is judged that substantially no conducting agent is contained.

Conducting agent particles that do not contribute to the creation of conductive path may become a site where self-discharge of the battery starts or a cause of undesirable side reactions.

### [Positive Electrode Current Collector]

The positive electrode current collector body 14 is formed of a metal material. Examples of the metal material include conductive metals such as copper, aluminum, titanium, nickel, and stainless steel.

The thickness of the positive electrode current collector main body 14 is preferably, for example, 8 to 40 μm, and more preferably 10 to 25 μm.

The thickness of the positive electrode current collector main body 14 and the thickness of the positive electrode current collector 11 can be measured using a micrometer. One example of the measuring instrument usable for this purpose is an instrument with the product name “MDH-25M”, manufactured by Mitutoyo Co., Ltd.

### [Current Collector Coating Layer]

The current collector coating layer 15 contains a conductive material.

The conductive material in the current collector coating layer 15 preferably contains carbon (conductive carbon), and more preferably consists exclusively of carbon.

The current collector coating layer 15 is preferred to be, for example, a coating layer containing carbon particles such as carbon black and a binder. Examples of the binder for the current collector coating layer 15 include those listed above as examples of the binder for the positive electrode active material layer 12.

With regard to the production of the positive electrode current collector 11 in which the surface of the positive electrode current collector main body 14 is coated with the current collector coating layer 15, for example, the production can be implemented by a method in which a composition (i.e., composition for preparing the current collector coating layer) containing the conductive material, the binder, and a solvent is applied to the surface of the positive electrode current collector main body 14 with a known coating method such as a gravure method, followed by drying to remove the solvent.

The thickness of the current collector coating layer 15 is preferably 0.1 to 4.0 μm, more preferably 0.2 to 2.0 μm, and even more preferably 0.5 to 1.2 μm. When the thickness is not lower than the lower limit of the above range, the impedance can be remarkably reduced. When the thickness is not more than the upper limit of the above range, the peel strength can be remarkably improved.

The thickness of the current collector coating layer can be measured by a method that measures the thickness of the coating layer in a transmission electron microscope (TEM) image or a scanning electron microscope (SEM) image of a cross section of the current collector coating layer. The thickness of the current collector coating layer need not be uniform.

When the current collector covering layers 15 are present on both surfaces of the positive electrode current collector main body 14, an average of the thickness values on the both surfaces may be within the above range.

### [Method for Producing Positive Electrode]

The positive electrode 1 of the present embodiment can be produced by a method comprising applying a positive electrode composition containing a positive electrode active material, a binder and a solvent onto a positive electrode current collector 11, followed by drying the positive electrode composition to form a positive electrode active material layer 12 on the positive electrode current collector 11 (active material layer-forming step).

The active material layer-forming step is performed to press a laminate in which the positive electrode active material layer 12 is formed on the positive electrode collector 11 in a thickness direction against a surface of the positive electrode collector 11 having the current collector coating layer 12, so that a ratio of thickness of the current collector coating layer 15 to thickness of the positive electrode active material layer 12 is adjusted to more than 0.000 and less than 0.020.

The positive electrode composition may contain a conducting agent.

The thickness of the positive electrode active material layer 12 can be adjusted by a method in which a layered body composed of the positive electrode current collector 11 and the positive electrode active material layer 12 formed thereon is placed between two flat plate jigs and, then, uniformly pressurized in the thickness direction of this layered body. For this purpose, for example, a method of pressurizing using a roll press can be used.

The solvent for the positive electrode composition is preferably a non-aqueous solvent. Examples of the solvent include alcohols such as methanol, ethanol, 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination.

In the present embodiment, the ratio of the thickness of the current collector coating layer to the thickness of the positive electrode active material layer (hereinafter, also referred to as “thickness ratio X”) is more than 0.000 and less than 0.020, preferably 0.001 to 0.0019, more preferably 0.003 to 0.017, and even more preferably 0.005 to 0.015, even more preferably 0.07 to 0.015, even more preferably 0.010 to 0.015, particularly preferably 0.0013 to 0.015. When this ratio is not lower than the lower limit of the above range, it is possible to achieve excellent effect of reducing the impedance of the non-aqueous electrolyte secondary battery. When the ratio is not more than the upper limit of the above range, the energy density per volume or weight increases.

When the current collector coating layer 15 is present on both surfaces of the positive electrode current collector main body 14 and the positive electrode active material layer 12 is present on both surfaces of the positive electrode current collector 11, a ratio of the total thickness of the current collector coating layers 15 to the total thickness of the positive electrode active material layers 12 is defined as the thickness ratio X.

The thickness of the positive electrode active material layer 12 (total thickness of the positive electrode active material layer 12 on both sides of the positive electrode current collector 11 when the positive electrode active material layer 12 is present on both sides) is preferably 120 to 800 μm, more preferably 130 to 600 μm, even more preferably 140 to 500 μm. In one embodiment of the present invention, the thickness of the positive electrode active material layer 12 may be 130 to 145 μm. When the total thickness is within the above range, it is easy to adjust the thickness ratio X to a preferable range. In particular, the total thickness of 500 μm or less is preferable in that the positive electrode shows excellent effect of improving the peel strength of the positive electrode active material layer and excellent effect of improving the high-rate cycle performance of the non-aqueous electrolyte secondary battery.

When the positive electrode active material layers 12 are provided on both surfaces of the positive electrode current collector 11, both layers are usually formed under the same conditions such that the positive electrode active material layers on both surfaces have an equal thickness.

In the present embodiment, when the positive electrode active material layers 12 are present on both surfaces of the positive electrode current collector 11, the thickness of the positive electrode 1 excluding the positive electrode current collector main body 14 (hereinafter, also referred to as “current collector main body-excluded thickness”) is preferably 50 to 500 μm, more preferably 100 to 460 μm, and even more preferably 140 to 310 μm. When this ratio is not lower than the lower limit of the above range, it is possible to achieve excellent effect of reducing the impedance of the non-aqueous electrolyte secondary battery. When the ratio is not more than the upper limit of the above range, the energy density per volume or weight increases.

The current collector main body-excluded thickness is obtained by subtracting the thickness of the positive electrode current collector main body 14 from the thickness of the entire positive electrode. The thickness values for this calculation can be obtained by measurement using a micrometer. The thickness of the positive electrode current collector main body 14 can be measured after removing the current collector coating layer 15 at the exposed section 13 of the positive electrode current collector. Each thickness value is obtained by implementing measurement at 5 arbitrarily chosen points, and calculating an average value.

When the positive electrode is composed of the positive electrode current collector 11 and the positive electrode active material layers 12 present on both surfaces of the positive electrode current collector 11, the thickness of the single positive electrode active material layer 12 can be obtained as ½ of the value obtained by subtracting the total thickness of the current collector coating layers 15 on both surfaces from the value of the current collector main body-excluded thickness.

In the present embodiment, the mass of the positive electrode active material layer 12 per unit area is preferably 30 to 150 mg/cm², more preferably 31 to 100 mg/cm², and even more preferably 32 to 70 mg/cm².

In the context of the present specification, the mass per unit area of the positive electrode active material layer is a total value for the positive electrode active material layers present on both surfaces of the positive electrode current collector unless otherwise specified.

The mass per unit area of the positive electrode active material layer 12 can be measured by, for example, the following measuring method.

The mass of the measurement sample punched out from the positive electrode so as to have a predetermined area is measured, from which the mass of the positive electrode current collector 11 measured in advance is subtracted to calculate the mass of the positive electrode active material layer.

From the ratio: mass of positive electrode active material layer (unit: mg)/area of measurement sample (unit: cm²), the mass the positive electrode active material layer 12 per unit area (unit: mg/cm²) is determined.

When the mass of the positive electrode active material layer 12 per unit area is not lower than the lower limit of the above range, the energy density per volume or mass increases. When the mass of the positive electrode active material layer 12 per unit area not higher than the upper limit of the above range, excellent effect of reducing the impedance of the non-aqueous electrolyte secondary battery is achieved.

The mass of the positive electrode active material layer 12 per unit area can be controlled, for example, by adjusting the coating amount of the positive electrode composition.

In the present embodiment, the peel strength of the positive electrode active material layer 12 is preferably 7 to 1,000 mN/cm, more preferably 10 to 700 mN/cm, even more preferably 20 to 500 mN/cm, and particularly preferably 50 to 300 mN/cm.

In the context of the present specification, the peel strength of the positive electrode active material layer 12 is the 180° peel strength obtained by the measuring method described in the Examples section described below.

When the peel strength of the positive electrode active material layer 12 is not less than the lower limit value of the above range, excellent binding is achieved between the particles forming the positive electrode active material layer 12, and excellent adhesion is achieved between the positive electrode current collector 11 and the positive electrode active material layer 12. When the peel strength is not more than the upper limit, the energy density per volume or mass increases.

The peel strength can be controlled, for example, by adjusting the mass per unit area of the positive electrode active material layer 12, the thickness of the positive electrode active material layer 12, the amount of the binder, and the amount of the conducting agent. As the mass per unit area of the positive electrode active material layer 12 is increased to increase the thickness of the positive electrode active material layer 12, the peel strength tends to decrease. The larger the amount of the binder, the higher the peel strength. By reducing the amount of the conducting agent, which has a large surface area and requires more binder than the active material, the amount of binder required to obtain satisfactory peel strength can be reduced.

In the present embodiment, one or both of the positive electrode current collector 11 and the positive electrode active material layer 12 preferably include conductive carbon.

When the positive electrode active material layer 12 contains conductive carbon, it is preferable that at least one of the conductive material coating the positive electrode active material and the conducting agent contains the carbon.

When the positive electrode current collector 11 contains conductive carbon, it is preferable that the conductive material in the current collector coating layer 15 contains the carbon.

The positive electrode 1 preferably has a conductive carbon content of 0.5 to 3.5% by mass, more preferably 1.5 to 3.0% by mass, with respect to the mass of the positive electrode 1 excluding the positive electrode current collector main body 14.

When the positive electrode 1 is composed of the positive electrode current collector main body 14, the current collector coating layer 15, and the positive electrode active material layer 12, the mass of the positive electrode 1 excluding the positive electrode current collector main body 14 is the sum of the mass of the current collector coating layer 15 and the mass of the positive electrode active material layer 12.

The amount of the conductive carbon with respect to the mass of the positive electrode 1 excluding the positive electrode current collector main body 14 can be measured by <<Method for measuring conductive carbon content>> described below with respect to a dried product (powder), as a measurement target, obtained by detaching the whole of a layer present on the positive electrode current collector main body 14, collecting the whole of substance resulting from the detached layer, and vacuum-drying the collected substance at 120° C.

The conductive carbon to be measured by the <<Method for measuring conductive carbon content>> described below includes carbon in the coated section of the positive electrode active material, carbon in the conducting agent, and carbon in the current collector coating layer 15. Carbon in the binder is not included in the conductive carbon to be measured.

As a method for obtaining the measurement target, for example, the following method can be adopted.

First, the layer (powder) present on the positive electrode current collector main body 14 is completely detached by a method in which the positive electrode 1 is punched to obtain a piece having a predetermined size, and the piece of the positive electrode current collector main body 14 is immersed in a solvent (for example, N-methylpyrrolidone) and stirred. Next, after confirming that no powder remains attached to the positive electrode current collector main body 14, the positive electrode current collector main body 14 is taken out from the solvent to obtain a suspension (slurry) containing the detached powder and the solvent. The obtained suspension is dried at 120° C. to completely volatilize the solvent to obtain the desired measurement target (powder).

### <<Method for Measuring Conductive Carbon Content>>

### [Measurement Method A]

A sample having a weight w1 is taken from a homogeneously mixed product of the measurement target, and the sample is subjected to thermogravimetry differential thermal analysis (TG-DTA) implemented by following step A1 defined below, to obtain a TG curve. From the obtained TG curve, the following first weight loss amount M1 (unit: % by mass) and second weight loss amount M2 (unit: % by mass) are obtained. By subtracting M1 from M2, the conductive carbon content (unit: % by mass) is obtained.

Step A1: A temperature of the sample is raised from 30° C. to 600° C. at a heating rate of 10° C./min and holding the temperature at 600° C. for 10 minutes in an argon gas stream of 300 mL/min to measure a resulting mass w2 of the sample, from which a first weight loss amount M1 is determined by formula (a1):

$$M 1 = ( w 1 - w 2 ) / w 1 \times 100 \qquad ( a1 )$$

Step A2: Immediately after the step A1, the temperature is lowered from 600° C. to 200° C. at a cooling rate of 10° C./min and held at 200° C. for 10 minutes, followed by completely substituting the argon gas stream with an oxygen gas stream. The temperature is raised from 200° C. to 1000° C. at a heating rate of 10° C./min and held at 1000° C. for 10 minutes in an oxygen gas stream of 100 mL/min to measure a resulting mass w3 of the sample, from which a second weight loss amount M2 (unit: % by mass) is calculated by formula (a2):

$$M 2 = ( w 1 - w 3 ) / w 1 \times 100 \qquad ( a2 )$$

### [Measurement Method B]

0.0001 mg of a precisely weighed sample is taken from a homogeneously mixed product of the measurement target, and the sample is burnt under burning conditions defined below to measure an amount of generated carbon dioxide by a CHN elemental analyzer, from which a total carbon content M3 (unit: % by mass) of the sample is determined. Also, a first weight loss amount M1 is determined following the procedure of the step A1 of the measurement method A. By subtracting M1 from M3, the conductive carbon content (unit: % by mass) is obtained.

### [Burning Conditions]

Combustion furnace temperature: 1150° C.
Temperature of reduction furnace: 850° C.
Helium flow rate: 200 mL/min.
Oxygen flow rate: 25 to 30 mL/min.

### [Measurement Method C]

The total carbon content M3 (unit: % by mass) of the sample is measured in the same manner as in the above measurement method B. Further, the carbon amount M4 (unit: % by mass) of carbon derived from the binder is determined by the following method. M4 is subtracted from M3 to determine a conductive carbon content (unit: % by mass).

When the binder is polyvinylidene fluoride (PVDF: monomer (CH2_{CF}2), molecular weight 64), the conductive carbon content can be calculated by the following formula from the fluoride ion (F₋) content (unit: % by mass) measured by combustion ion chromatography based on the tube combustion method, the atomic weight (19) of fluorine in the monomers constituting PVDF, and the atomic weight (12) of carbon in the PVDF.

PVDF content (unit: % by mass)=fluoride ion content (unit: % by mass)×64/38

PVDF-derived carbon amount M4 (unit: % by mass)=fluoride ion content (unit: % by mass)×12/19

The presence of polyvinylidene fluoride as a binder can be verified by a method in which a sample or a liquid obtained by extracting a sample with an N,N-dimethylformamide solvent is subjected to Fourier transform infrared spectroscopy to confirm the absorption attributable to the C—F bond. Such verification can be likewise implemented by nuclear magnetic resonance spectroscopy (¹⁹F-NMR).

When the binder is identified as being other than PVDF, the carbon amount M4 attributable to the binder can be calculated by determining the amount (unit: % by mass) of the binder from the measured molecular weight, and the carbon content (unit: % by mass).

These methods are described in the following publications:

Toray Research Center, The TRC News No. 117 (September 2013), pp. 34-37, [Searched on Feb. 10, 2021], Internet <https://www.toray-research.co.jp/technical-info/trcnews/pdf/TRC117(34-37).pdf>

TOSOH Analysis and Research Center Co., Ltd., Technical Report No. T1019 2017.09.20, [Searched on Feb. 10, 2021], Internet <http://www.tosoh-arc.co.jp/techrepo/files/tarc00522/T1719N.pdf>

### <<Analytical Method for Conductive Carbon>>

The conductive carbon in the active material coating section of the positive electrode active material and the conductive carbon as the conducting agent can be distinguished by the following analytical method.

For example, particles in the positive electrode active material layer are analyzed by a combination of transmission electron microscopy-electron energy loss spectroscopy (TEM-EELS), and particles having a carbon-derived peak around 290 eV only near the particle surface can be judged to be the positive electrode active material. On the other hand, particles having a carbon-derived peak inside the particles can be judged to be the conducting agent.

As another method, the particles in the positive electrode active material layer are analyzed by Raman spectroscopy mapping, and particles showing carbon-derived G-band and D-band as well as a peak of the positive electrode active material-derived oxide crystals can be judged to be the positive electrode active material. On the other hand, particles showing only G-band and D-band can be judged to be the conducting agent.

As still another method, a cross section of the positive electrode active material layer is observed with scanning spread resistance microscope (SSRM). When the particle surface has a region with lower resistance than the inside of the particle, the region with lower resistance can be judged to be the conductive carbon present in the coated section of the active material. Other particles that are present isolatedly and have low resistance can be judged to be the conducting agent.

In this context, a trace amount of carbon considered to be an impurity and a trace amount of carbon unintentionally detached from the surface of the positive electrode active material during production are not judged to be the conducting agent.

Using any of these methods, it is possible to verify whether or not the conducting agent formed of carbon material is contained in the positive electrode active material layer.

### <Non-Aqueous Electrolyte Secondary Battery>

The non-aqueous electrolyte secondary battery 10 of the present embodiment shown in FIG. 2 includes a positive electrode 1 of the present embodiment, a negative electrode 3, and a non-aqueous electrolyte. Further, a separator 2 may be provided. Reference numeral 5 in FIG. 1 denotes an outer casing.

In the present embodiment, the positive electrode 1 has a plate-shaped positive electrode current collector 11 and positive electrode active material layers 12 provided on both surfaces thereof. The positive electrode active material layer 12 is present on a part of each surface of the positive electrode current collector 11. The edge of the surface of the positive electrode current collector 11 is an exposed section 13 of the positive electrode current collector, which is free of the positive electrode active material layer 12. A terminal tab (not shown) is electrically connected to an arbitrary portion of the exposed section 13 of the positive electrode current collector.

The negative electrode 3 has a plate-shaped negative electrode current collector 31 and negative electrode active material layers 32 provided on both surfaces thereof. The negative electrode active material layer 32 is present on a part of each surface of the negative electrode current collector 31. The edge of the surface of the negative electrode current collector 31 is an exposed section 33 of the negative electrode current collector, which is free of the negative electrode active material layer 32. A terminal tab (not shown) is electrically connected to an arbitrary portion of the exposed section 33 of the negative electrode current collector.

The shapes of the positive electrode 1, the negative electrode 3 and the separator 2 are not particularly limited. For example, each of these may have a rectangular shape in a plan view.

With regard to the production of the non-aqueous electrolyte secondary battery 10 of the present embodiment, for example, the production can be implemented by a method in which the positive electrode 1 and the negative electrode 3 are alternately interleaved through the separator 2 to produce an electrode layered body, which is then packed into an outer casing such as an aluminum laminate bag, and a non-aqueous electrolyte (not shown) is injected into the outer casing, followed by sealing the outer casing.

FIG. 2 shows a representative example of a structure of the battery in which the negative electrode, the separator, the positive electrode, the separator, and the negative electrode are stacked in this order, but the number of electrodes can be altered as appropriate. The number of the positive electrode 1 may be one or more, and any number of positive electrodes 1 can be used depending on a desired battery capacity. The number of each of the negative electrode 3 and the separator 2 is larger by one sheet than the number of the positive electrode 1, and these are stacked so that the negative electrode 3 is located at the outermost layer.

### [Negative Electrode]

The negative electrode active material layer 32 includes a negative electrode active material. Further, the negative electrode active material layer 32 may further include a binder. Furthermore, the negative electrode active material layer 32 may include a conducting agent as well. The shape of the negative electrode active material is preferably particulate.

For example, the negative electrode 3 can be produced by a method in which a negative electrode composition containing a negative electrode active material, a binder and a solvent is prepared, and coated on the negative electrode current collector 31, followed by drying to remove the solvent to thereby form a negative electrode active material layer 32. The negative electrode composition may contain a conducting agent.

Examples of the negative electrode active material and the conducting agent include carbon materials such as graphite, graphene, hard carbon, Ketjen black, acetylene black, and carbon nanotube (CNT). With respect to each of the negative electrode active material and the conducting agent, a single type thereof may be used alone or two or more types thereof may be used in combination.

Examples of the material of the negative electrode current collector 31, the binder and the solvent in the negative electrode composition include those listed above as examples of the material of the positive electrode current collector 11, the binder and the solvent in the positive electrode composition. With respect to each of the binder and the solvent in the negative electrode composition, a single type thereof may be used alone or two or more types thereof may be used in combination.

The sum of the amount of the negative electrode active material and the amount of the conducting agent relative to the total mass of the negative electrode active material layer 32 is preferably 80.0 to 99.9% by mass, more preferably 85.0 to 98.0% by mass.

### [Separator]

The separator 2 is disposed between the negative electrode 3 and the positive electrode 1 to prevent a short circuit or the like. The separator 2 may retain anon-aqueous electrolyte described below.

The separator 2 is not particularly limited, and examples thereof include a porous polymer film, a non-woven fabric, and glass fiber.

An insulating layer may be provided on one or both surfaces of the separator 2. The insulating layer is preferably a layer having a porous structure in which insulating fine particles are bonded with a binder for an insulating layer.

The separator 2 may contain various plasticizers, antioxidants, and flame retardants.

Examples of the antioxidant include phenolic antioxidants such as hindered phenolic antioxidants, monophenolic antioxidants, bisphenolic antioxidants, and polyphenolic antioxidants; hindered amine antioxidants; phosphorus antioxidants; sulfur antioxidants; benzotriazole antioxidants; benzophenone antioxidants; triazine antioxidants; and salicylate antioxidants. Among these, phenolic antioxidants and phosphorus antioxidants are preferable.

### [Non-Aqueous Electrolyte Solution]

The non-aqueous electrolyte solution fills the space between the positive electrode 1 and the negative electrode 3. For example, any of known non-aqueous electrolyte solutions used in lithium ion secondary batteries, electric double layer capacitors and the like can be used.

The non-aqueous electrolyte used in the manufacture of the non-aqueous electrolyte secondary battery 10 contains an organic solvent, an electrolyte, and an additive.

After manufacture, especially after initial charging, the non-aqueous electrolyte secondary battery 10 contains an organic solvent and an electrolyte, and may further contain residues or traces derived from the additives.

The organic solvent is preferably one having tolerance to high voltage. Examples of the organic solvent include polar solvents such as ethylene carbonate, propylene carbonate, dimethyl carbonate, diethyl carbonate, ethyl methyl carbonate, γ-butyrolactone, sulfolane, dimethyl sulfoxide, acetonitrile, dimethylformamide, dimethylacetamide, 1,2-dimethoxyethane, 1,2-diethoxyethane, tetrohydrafuran, 2-methyltetrahydrofuran, dioxolane, and methyl acetate, as well as mixtures of two or more of these polar solvents.

The electrolyte salt is not particularly limited, and examples thereof include lithium-containing salts such as LiClO₄, LiPF₆, LiBF₄, LiAsF₆, LiCF₃CO₂, LiN(SO₂F)₂, LiN(SO₂CF₃)₂, Li(SO₂CF₂CF₃)₂, LiN(COCF₃)₂, and LiN(COCF₂CF₃)₂, as well as mixture of two or more of these salts.

The non-aqueous electrolyte secondary battery of the present embodiment can be used as a lithium ion secondary battery for various purposes such as industrial use, consumer use, automobile use, and residential use.

The application of the non-aqueous electrolyte secondary battery of this embodiment is not particularly limited. For example, the battery can be used in a battery module configured by connecting a plurality of non-aqueous electrolyte secondary batteries in series or in parallel, a battery system including a plurality of electrically connected battery modules and a battery control system, and the like.

Examples of the battery system include battery packs, stationary storage battery systems, automobile power storage battery systems, automobile auxiliary storage battery systems, emergency power storage battery systems, and the like.

The positive electrode of the present embodiment enables realization of a non-aqueous electrolyte secondary battery showing a low impedance with a lower ratio X, thickness of current collector coating layer/thickness of positive electrode active material layer, than the range specified in Patent Document 1.

### EXAMPLES

Hereinbelow, the present invention will be described with reference to Examples which, however, should not be construed as limiting the present invention.

### <Measuring Method>

### [Ratio of Thickness of the Current Collector Coating Layer to Thickness of the Positive Electrode Active Material Layer]

The thickness of each of the positive electrode sheet, the positive electrode current collector 11 and the positive electrode main body was measured using a micrometer. Each thickness was measured at 5 arbitrarily chosen points, and an average value was calculated.

The thickness of the positive electrode current collector 11 was measured at the exposed section 13 of the positive electrode current collector. The current collector coating layer 15 at the exposed section 13 of the positive electrode current collector was removed, and the thickness of the positive electrode current collector main body 14 was measured.

The thickness of the positive electrode current collector main body 14 was subtracted from the thickness of the positive electrode sheet to obtain the current collector main body-excluded thickness.

The thickness of the positive electrode active material layers (total value for both surfaces) was obtained by subtracting the thickness of the current collector coating layers (total value for both surfaces) from the value of the current collector main body-excluded thickness.

The ratio of the thickness of the current collector coating layers (total value for both surfaces) to the thickness of the positive electrode active material layers (total value for both surfaces) was determined as the thickness ratio X.

### [Measurement Method for Mass Per Unit Area of Positive Electrode Active Material Layer]

5 sheets of measurement samples were prepared by punching the positive electrode sheet into circles with a diameter of 16 mm.

The mass of each measurement sample was weighed with a precision balance, and the mass of the positive electrode active material layer in the measurement sample was calculated by subtracting the mass of the positive electrode current collector 11 measured in advance from the measurement result.

From the ratio: mass of positive electrode active material layer (unit: mg)/area of measurement sample (unit: cm²), the mass the positive electrode active material layer per unit area (unit: mg/cm²) was determined.

### [Measurement Method for Peel Strength]

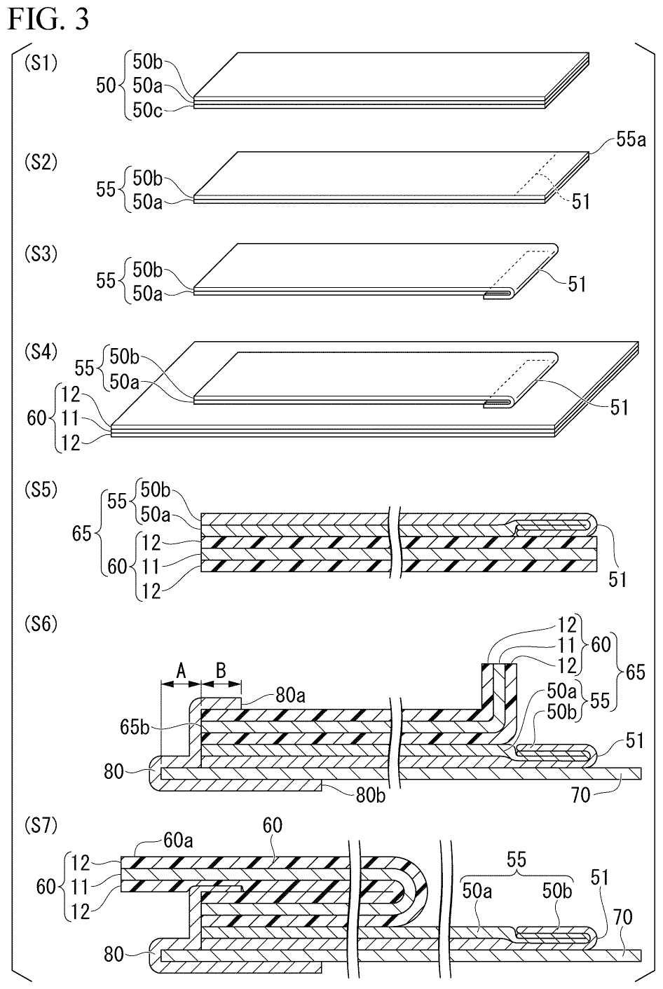

The peel strength of the positive electrode active material layer 12 can be measured by the following method using a tensile tester. FIG. 3 is a process diagram showing a method for measuring the peel strength of the positive electrode active material layer. The steps (S1) to (S7) shown in FIG. 3 are respectively described below. FIG. 3 is a schematic diagram for facilitating the understanding of the configuration, and the dimensional ratios and the like of each component do not necessarily represent the actual ones.

(S1) First, a rectangular double-sided tape 50 having a width of 25 mm and a length of 120 mm is prepared. In the double-sided tape 50, release papers 50b and 50c are laminated on both sides of the adhesive layer 50a. As the double-sided tape 50, a product manufactured and sold by Nitto Denko Corporation with a product name “No. 5015, 25 mm width” is used.

(S2) The release paper 50c on one side of the double-sided tape 50 is peeled off to obtain an adhesive body 55 with the surface of the adhesive layer 50a (hereinafter, also referred to as “glue surface”) being exposed. In the adhesive body 55, a bending position 51 is provided at a distance of about 10 mm from one end 55a in the longitudinal direction of the adhesive body 55.

(S3) The adhesive body 55 is bent at a position on the one end 55a side as viewed from the bending position 51 such that the glue surfaces adhere to each other.

(S4) The adhesive body 55 and the positive electrode sheet 60 are bonded together such that the glue surface of the adhesive body 55 and the positive electrode active material layer 12 of the positive electrode sheet 60 are in contact with each other.

(S5) The positive electrode sheet 60 is cut out along the outer edge of the adhesive body 55, and the adhesive body 55 and the positive electrode sheet 60 are crimped to obtain a composite 65 by a method of reciprocating a crimping roller twice in the longitudinal direction.

(S6) The outer surface of the composite 65 on the adhesive body 55 side is brought into contact with one surface of a stainless plate 70, and the other end 65b on the side opposite to the bending position 51 is fixed to the stainless plate 70 with a mending tape 80. As the mending tape 80, a product manufactured and sold by 3M Company with a product name “Scotch Tape Mending Tape 18 mm×30 Small Rolls 810-1-18D” is used. The length of the mending tape 80 is about 30 mm, the distance A from an end of the stainless plate 70 to the other end 65b of the composite 65 is about 5 mm, and the distance B from one end 80a of the mending tape 80 to the other end 65b of the composite 65 is 5 nm. The other end 80b of the mending tape 80 is attached to the other surface of the stainless plate 70.

(S7) At the end of the composite 65 on the bending position 51 side, the positive electrode sheet 60 is slowly peeled off from the adhesive 55 in parallel with the longitudinal direction. The end (hereinafter, referred to as “peeling end”) 60a of the positive electrode sheet 60 that is not fixed by the mending tape 80 is slowly peeled off until it protrudes from the stainless steel plate 70.

Next, the stainless plate 70 to which the composite 65 is fixed is installed on a tensile tester (product name “EZ-LX”, manufactured by Shimadzu Corporation) (not shown), the end of the adhesive 55 on the bending position 51 side is fixed, and the peeling end 60a of the positive electrode sheet 60 is pulled in the direction opposite to the bending position 51 (180° direction with respect to the bending position 51) at a test speed of 60 mm/min, a test force of 50,000 mN, and a stroke of 70 mm to measure the peel strength. The average value of the peel strength at a stroke of 20 to 50 mm is taken as the peel strength of the positive electrode active material layer 12.

### [Measurement Method for Impedance]

A cell was prepared so as to have a rated capacity of 1 Ah, and the obtained cell was charged at a constant current rate of 0.2 C rate (that is, 200 mA) and with a cut-off voltage of 3.6V at 25° C. (room temperature). Then, the cell was charged at a constant voltage with a cut-off current set at 1/10 of the above-mentioned charge current (that is, 20 mA), followed by measurement of impedance under the conditions of room temperature (25° C.) and frequency of 1 kHz.

The measurement was carried out by 4-terminal method in which a current terminal and a voltage terminal are attached to the positive and negative electrode tabs, respectively. As an example, an impedance analyzer manufactured by BioLogic was used for the measurement.

### [Method for Measuring Thickness of the Positive Electrode Active Material Coating Section]

A transmission electron microscope (TEM) image of the positive electrode active material was obtained, and the thickness of the active material coating was measured. The thickness was measured at 20 locations, and the average value is shown in Table 1. The measurement device used was HD2700 manufactured by Hitachi, Ltd. The acceleration voltage was 200 KV.

The measurement with respect to the positive electrode sheet 60 can likewise be implemented by detaching the positive electrode active material layer 12 with a solvent such as NMP, followed by drying, to remove the positive electrode active material.

### <Evaluation Method>

### [High Rate Cycle Test]

The capacity retention was evaluated following the procedures (1) to (7) below.
(1) A non-aqueous electrolyte secondary battery (cell) was manufactured so as to have a rated capacity of 1 Ah, and a cycle evaluation was carried out at room temperature (25° C.).
(2) The obtained cell was charged at a constant current rate of 0.2 C rate (that is, 200 mA) and with a cut-off voltage of 3.6 V, and then charged at a constant voltage with a cut-off current set at 1/10 of the above-mentioned charge current (that is, 20 mA).
(3) The cell was discharged for capacity confirmation at a constant current rate of 0.2 C and with a cut-off voltage of 2.5 V. The discharge capacity at this time was set as the reference capacity, and the reference capacity was set as the current value at 1 C rate (that is, 1,000 mA).
(4) After charging the cell at a constant current at a cell's 3 C rate (that is, 3000 mA) and with a cut-off voltage of 3.8 V, a 10-second pause was provided. From this state, the cell was discharged at 3 C rate and with a cut-off voltage of 2.0 V, and a 10-second pause was provided.
(5) The cycle test of (4) was repeated 1,000 times.
(6) After performing the same charging as in (2), the same capacity confirmation as in (3) was performed.
(7) By dividing the discharge capacity in the capacity confirmation measured in (6) by the reference capacity before the cycle test to obtain a capacity retention after 1,000 cycles in terms of percentage (1,000 cycle capacity retention, unit: %).

### Production Example 1: Production of Negative Electrode

100 parts by mass of artificial graphite as a negative electrode active material, 1.5 parts by mass of styrene-butadiene rubber as a binder, 1.5 parts by mass of carboxymethyl cellulose Na as a thickener, and water as a solvent were mixed, to thereby obtain a negative electrode composition having a solid content of 50% by mass.

The obtained negative electrode composition was applied onto both sides of a copper foil (thickness 8 μm) and vacuum dried at 100° C. Then, the resulting was pressure-pressed under a load of 2 kN to obtain a negative electrode sheet. The obtained negative electrode sheet was punched to obtain a negative electrode.

### Examples 1 to 9

Examples 1 to 5, 8 and 9 are implementation of the present invention, while Examples 6 and 7 are comparative examples.

As the positive electrode active material, Examples 1 to 6 used carbon-coated lithium iron phosphate with an average particle size of 1.0 μm, a carbon content of 1% by mass, and a coating section average thickness of 13 nm.

Example 7 used lithium iron phosphate having no coating section, which had an average particle size of 1.0 μm, and a carbon content of 0% by mass.

Example 8 used carbon-coated lithium iron phosphate with an average particle size of 0.8 μm, a carbon content of 0.5% by mass, and a coating section average thickness of 2 nm.

Example 9 used carbon-coated lithium iron phosphate with an average particle size of 12.1 μm, a carbon content of 3.0% by mass, and a coating section average thickness of 53 nm.

Carbon black was used as a conducting agent.

Polyvinylidene fluoride (PVDF) was used as a binder.

### Example 1

First, a positive electrode current collector 11 was prepared by coating both the front and back surfaces of a positive electrode current collector main body 14 with current collector coating layers 15 by the following method. An aluminum foil (thickness 15 μm) was used as the positive electrode current collector main body 14.

A slurry was obtained by mixing 100 parts by mass of carbon black, 40 parts by mass of polyvinylidene fluoride as a binder, and N-methylpyrrolidone (NMP) as a solvent. The amount of NMP used was the amount required for applying the slurry.

The obtained slurry was applied to both surfaces of the positive electrode current collector main body 14 by a gravure method and dried to remove the solvent to form current collector coating layers 15, thereby obtaining a positive electrode current collector 11. The amount of slurry applied was set so as to give a total thickness of the current collector coating layers 15 on both surfaces as shown in Table 2. The current collector coating layers 15 on both surfaces were formed so as to have the same amount of coating and the same thickness.

Next, a positive electrode active material layer 12 was formed by the following method.

With the blending ratio shown in Table 1, the positive electrode active material, carbon black as a conducting agent, PVDF as a binder, and NMP as a solvent were mixed with a mixer to obtain a positive electrode composition. The amount of the solvent used was the amount required for applying the positive electrode composition.

The positive electrode composition was applied on both sides of the positive electrode current collector 11, and after pre-drying, the applied composition was vacuum-dried at 120° C. to form positive electrode active material layers 12. The coating amount of the positive electrode composition was set so that the mass of the positive electrode active material layer per unit area equals the value shown in Table 2. The resulting laminate was pressure-pressed with a load of 10 kN to obtain a positive electrode sheet. The positive electrode active material layers 12 on both surfaces of the positive electrode current collector 11 were formed so as to have the same coating amount and the same thickness.

Using the obtained positive electrode sheet as a sample, the current collector main body-excluded thickness, the thickness of the current collector coating layer (total value for both surfaces), the thickness of the positive electrode active material layer (total value for both surfaces), and the thickness ratio X (thickness of the current collector coating layer/thickness of the positive electrode active material layer), the mass per unit area of the positive electrode active material layer, and the peel strength were measured. These results are shown in Table 2 (the same applies to the other examples).

The obtained positive electrode sheet was punched to obtain a positive electrode.

A non-aqueous electrolyte secondary battery having a configuration shown in FIG. 2 was manufactured by the following method.

LiPF₆ as an electrolyte was dissolved at 1 mol/L in a solvent in which ethylene carbonate (EC) and diethyl carbonate (DEC) were mixed at a volume ratio, EC:DEC, of 3:7, to thereby prepare a non-aqueous electrolytic solution.

The positive electrode obtained in this example and the negative electrode obtained in Production Example 1 were alternately interleaved through a separator to prepare an electrode layered body with its outermost layer being the negative electrode. A polyolefin film (thickness 15 μm) was used as the separator.

In the step of producing the electrode layered body, the separator 2 and the positive electrode 1 were first stacked, and then the negative electrode 3 was stacked on the separator 2.

Terminal tabs were electrically connected to the exposed section 13 of the positive electrode current collector and the exposed section 33 of the negative electrode current collector in the electrode layered body, and the electrode layered body was put between aluminum laminate films while allowing the terminal tabs to protrude to the outside. Then, the resulting was laminate-processed and sealed at three sides.

To the resulting structure, a non-aqueous electrolytic solution was injected from one side left unsealed, and this one side was vacuum-sealed to manufacture a non-aqueous electrolyte secondary battery (laminate cell).

The impedance was measured by the above method. Further, the high rate cycle test was carried out by the above method to measure the 1,000-cycle capacity retention. The results are shown in Table 2 (the same applies to the other examples).

### Examples 2 to 4

The coating amount of the positive electrode composition was changed from Example A1 to change the thickness of the positive electrode active material layer. Except for these points, the same procedures as in Example 1 were repeated to prepare a positive electrode, and manufacture and evaluate a secondary battery.

### Example 5

In this example, a positive electrode was produced without using a conducting agent. The blending ratio for the positive electrode composition was changed from Example A1 as shown in Table 1. The coating amount and thickness of the positive electrode active material layer were changed from Example A1 as shown in Table 2. Except for these points, the same procedures as in Example 1 were repeated to prepare a positive electrode, and manufacture and evaluate a secondary battery.

### Example 6

A positive electrode was produced in the same manner as in Example 1 except that the current collector coating layer 15 was not provided, and a secondary battery was manufactured and evaluated in the same manner as in Example 1.

### Example 7

A positive electrode and a secondary battery were produced in the same manner as in Example 1 expect that the positive electrode active material coating section was changed as shown in Table 1, and the coating amount and thickness for the positive electrode active material layer were changed as shown in Table 2, and the secondary battery was evaluated.

### Examples 8 and 9

A positive electrode and a secondary battery were produced in the same manner as in Example 1 expect that the positive electrode active material coating section was changed as shown in Table 1, and the secondary battery was evaluated.

TABLE 1

| | | Blending ratio for the positive electrode | | | |
|---|---|---|---|---|---|
| | Positive electrode | composition [Parts by mass] | | | |
| | active material | Positive | | | |
| | coating section | electrode | | | |
| | Thickness | active | Conducting | | |
| | (nm) | material | agent | Binder | Solvent |
| Ex. 1 | 13 | 98.0 | 1.0 | 1.0 | Required |
| Ex. 2 | 13 | 98.0 | 1.0 | 1.0 | quantity |
| Ex. 3 | 13 | 98.0 | 1.0 | 1.0 | |
| Ex. 4 | 13 | 98.0 | 1.0 | 1.0 | |
| Ex. 5 | 13 | 99.5 | — | 0.5 | |
| Ex. 6 | 13 | 94.0 | 5.0 | 1.0 | |
| Ex. 7 | 0 | 94.0 | 5.0 | 1.0 | |
| Ex. 8 | 2 | 98.0 | 1.0 | 1.0 | |
| Ex. 9 | 53 | 98.0 | 1.0 | 1.0 | |

TABLE 2

| | | Thickness | Thickness | | | | | |
|---|---|---|---|---|---|---|---|---|
| | | of current | of positive | | Mass per unit | | | |
| | Current | collector | electrode | | area of positive | | | 1,000 cycle |
| | collector | coating | active material | | electrode active | | | capacity |
| | main body- | layer (total | layer (total | Thick- | material layer | | Imped- | retention |
| | excluded | for both | for both | ness | (total for | Peel | ance | (25° C., |
| | thickness | sides) | sides) | ratio X | both sides) | strength | (1 kHz) | 3 C rate) |
| | Unit | | | | | | | |
| | μm | μm | μm | — | mg/cm² | mN/cm | mΩ | % |
| Ex. 1 | 152 | 2 | 150 | 0.013 | 33 | 64.4 | 8.2 | 89 |
| Ex. 2 | 302 | 2 | 300 | 0.007 | 66 | 31.9 | 9.7 | 87 |
| Ex. 3 | 452 | 2 | 450 | 0.004 | 99 | 23.3 | 13.4 | 82 |
| Ex. 4 | 602 | 2 | 600 | 0.003 | 132 | 8.7 | 17.7 | 72 |
| Ex. 5 | 142 | 2 | 140 | 0.014 | 32 | 75.9 | 7.5 | 94 |
| Ex. 6 | 150 | 0 | 150 | 0.000 | 33 | 75.2 | 38.1 | 55 |
| Ex. 7 | 142 | 2 | 140 | 0.014 | 32 | 81.8 | 75.6 | 17 |
| Ex. 8 | 152 | 2 | 150 | 0.013 | 33 | 70.1 | 12.5 | 80 |
| Ex. 9 | 152 | 2 | 150 | 0.013 | 33 | 14.6 | 4.9 | 84 |

As can be understood from the results shown in Table 2, the impedance of the non-aqueous electrolyte secondary battery could be suppressed to a low level and a good capacity retention was shown in high rate charge/discharge cycle at 3 C in Examples 1 to 5, 8 and 9 where the positive electrode current collector had a current collector coating layer, the positive electrode active material was lithium iron phosphate having a coating layer, and the thickness ratio X was more than 0.000 and less than 0.020.

In Example 6 where the current collector coating layer was not provided and the thickness ratio X was zero, the impedance of the non-aqueous electrolyte secondary battery was significantly higher than Example 1.

In Example 7 where the active material had no coating section and the thickness of coating section is 0, the impedance of the non-aqueous electrolyte secondary battery was significantly higher and the capacity retention in the charge/discharge cycles was lower than in Example 1.

Generally, it is expected that an increase in the thickness of the positive electrode active material layer causes deterioration of the conductive path and the impedance is liable to increase. However, in Examples 1 to 5, 8 and 9, the increase in impedance accompanying the increase in the thickness of the positive electrode active material layer was suppressed to a low level.

### EXPLANATION OF REFERENCE NUMERALS

1 Positive electrode
2 Separator
3 Negative electrode
5 Outer casing
10 Secondary battery
11 Positive electrode current collector
12 Positive electrode active material layer
13 Exposed section of positive electrode current collector
14 Positive electrode current collector main body
15 Current collector coating layer
31 Negative electrode current collector
32 Negative electrode active material layer
33 Exposed section of negative electrode current collector
50 Double-sided tape
50a Adhesive layer
50b Release paper
51 Bending position
55 Adhesive body
60 Positive electrode sheet
70 Stainless steel plate
80 Mending tape

1. A positive electrode for a non-aqueous electrolyte secondary battery, comprising: a positive electrode current collector comprising a positive electrode current collector main body formed of a metal material; and a positive electrode active material layer provided on the positive electrode current collector, wherein:
the positive electrode active material layer comprises a positive electrode active material;
the positive electrode active material has, on at least a part of its surface, an active material coating section comprising a conductive material;
the positive electrode current collector main body has, on at least a part of its surface on a side of the positive electrode active material layer, a current collector coating layer comprising a conductive material;
the positive electrode active material layer has a thickness of 1 to 100 nm; and
a ratio of thickness of the current collector coating layer to thickness of the positive electrode active material layer is more than 0.000 and less than 0.020.

2. The positive electrode for a non-aqueous electrolyte secondary battery according to claim 1, wherein the positive electrode active material layer is present on both surfaces of the positive electrode current collector, and a total mass per unit area of the positive electrode active material layer on the both surfaces is 30 to 150 mg/cm².

3. The positive electrode according to claim 1, wherein the positive electrode active material layer has a peel strength of 7 to 1,000 mN/cm.

4. The positive electrode according to claim 1, wherein the positive electrode active material layer is present on both surfaces of the positive electrode current collector, and a thickness of the positive electrode excluding the positive electrode current collector main body is 50 to 500 μm.

5. The positive electrode active material according to claim 1, wherein the positive electrode active material comprises a compound represented by a formula LiFeₓM₍₁₋ₓ₎PO₄, wherein 0≤x≤1, M is Co, Ni, Mn, Al, Ti or Zr.

6. The positive electrode according to claim 5, wherein the positive electrode active material is lithium iron phosphate represented by LiFePO₄.

7. The positive electrode according to claim 1, wherein the positive electrode active material layer further comprises a conducting agent.

8. The positive electrode according to claim 1, wherein the positive electrode active material layer does not contain a conducting agent.

9. A non-aqueous electrolyte secondary battery, comprising the positive electrode of claim 1, a negative electrode, and a non-aqueous electrolyte disposed between the positive electrode and the negative electrode.

10. A battery module or battery system comprising a plurality of the non-aqueous electrolyte secondary batteries of claim 9.

11. A method for producing a positive electrode for a non-aqueous electrolyte secondary battery, comprising:
active material layer-forming by applying a positive electrode composition containing a positive electrode active material, a binder and a solvent onto a positive electrode current collector, followed by drying the positive electrode composition to form a positive electrode active material layer on the positive electrode current collector, wherein:
the positive electrode current collector has a positive electrode current collector main body formed of a metal material, and a current collector coating layer covering at least a part of surface of the positive electrode current collector main body,
the positive electrode active material has, on at least a part of its surface, an active material coating section comprising a conductive material, and
the active material layer-forming is performed to press a laminate in which the positive electrode active material layer is formed on the positive electrode collector in a thickness direction against a surface of the positive electrode collector having the current collector coating layer, so that a ratio of thickness of the current collector coating layer to thickness of the positive electrode active material layer is adjusted to more than 0.000 and less than 0.020.

12. A method for producing a non-aqueous electrolyte secondary battery, comprising:
producing a positive electrode for a non-aqueous electrolyte secondary battery by the method of claim 11; and
non-aqueous electrolyte-forming by disposing a non-aqueous electrolyte between the positive electrode for a non-aqueous electrolyte secondary battery and a negative electrode.
